(19) United States
(12) Patent Application Publication
(10) Pub. No.: US 2024/0109211 A1
(43) Pub. Date: Apr. 4, 2024

(54) BLADE SET FOR A HAIR CUTTING MACHINE

(71) Applicant: Wahl GmbH, St. Georgen (DE)

(72) Inventor: Heinrich SCHWER, Unterkirnach (DE)

(21) Appl. No.: 18/276,126

(22) PCT Filed: Jan. 27, 2022
(86) PCT No.: PCT/EP2022/051928

§ 371 Date: Aug. 7, 2023

(30) Foreign Application Priority Data
Feb. 5, 2021 (EP) 21155642.8

(51) Int. Cl. B26B 19/38; B26B 19/06

(52) U.S. Cl. CPC B26B 19/3846; B26B 19/06

(57) ABSTRACT

A blade set for a hair cutting machine is provided which has a main part and a blade set fixed thereto, wherein the blade set has a stationary blade and a movable blade, the movable blade having a base portion having a tooth end having a plurality of teeth formed parallel to each other, wherein the tooth tips of the teeth extend toward the outside in the longitudinal direction of the hair cutting machine in a cutting region of the blade set. The blade set includes the teeth of the movable blade are sized in such that the width thereof is substantially smaller in the region of the particular tooth tip than a distance between two respective adjacently arranged teeth.

### CROSS-REFERENCE TO RELATED APPLICATIONS

This application claims priority to PCT Application No. PCT/EP2022/051928, having a filing date of Jan. 27, 2022, which claims priority to EP Application No. 21155642.8, having a filing date of Feb. 5, 2021, the entire contents both of which are hereby incorporated by reference.

### FIELD OF TECHNOLOGY

The following relates to a blade set for a hair cutting machine and to a blade.

### BACKGROUND

Electric hair cutting machines have been known for a long time and include, among other things, a blade set provided at a front end of the body of the hair cutting machine and suitable for cutting hair.

The blade set of a hair cutting machine generally has two blades, firstly a stationary blade which comes into contact with the skin of the person or animal being treated or the user, namely the so-called shearing comb, and a movable blade, also known as a clipper blade. Each blade has a series of spaced teeth, the teeth being generally spaced at regular intervals.

Both blades of a blade set usually also have a tooth edge corresponding to the hair or skin of the person or animal to be treated. The two blades of the blade set are arranged such that the respective tooth edges overlap each other. In operation, the movable blade moves back and forth relative to the fixed or stationary blade to perform the cutting operation. During this reciprocating motion, the tooth edge of the movable blade interacts with the teeth of the stationary blade to allow cutting of hairs caught between each tooth in a scissor motion.

Thus, the strands of hair that enter between the teeth of the stationary blade are cut when the teeth of the movable blade move back and forth across the teeth of the stationary blade.

The movable blade is also referred to below as the shear blade or simply as the “knife”. The stationary blade is also referred to as the shearing comb or simply as the “comb”.

The hair is cut when the cutting elements, i.e., the teeth, of the shearing blade are moved over the corresponding blade pieces of the stationary shearing comb. The hair that is located in the area between the teeth during this shearing movement is cut off.

Usually, two types of hair cutting are distinguished, namely cutting hair at a certain distance from the skin of the person or animal being treated and cutting and removing hair close to the skin.

Both types of hair cutting require that cutting should be done with sufficient cutting power, i.e., both quickly and thoroughly, i.e., all the hairs of the area that is swept with the hair cutting machines should be removed in one operation and as far as possible without pulling, so that precise work is possible and cutting is comfortable for the person being treated.

Cutting close to the skin also has the additional requirement of not causing skin injuries to humans as well as animals. The occurrence of such injuries is possible if the distance between the shear comb tip and the shear blade tip is minimal, so that both tips almost overlap. However, a minimal distance between the shearing comb tip and the clipper blade tip is necessary for cutting longer hair close to the skin with trimmers or hair cutting machines. Electric shavers, which are based on a different cutting concept, also cut close to the skin, but are not suitable for cutting longer hair, only for cutting very short hair or hair stubble.

In order to prevent injury to the skin, the conventional art provides that the cutting edge of the movable blade is offset backward relative to the stationary blade, namely the blade facing the skin, so that the stationary blade serves as a spacer or distance guard to prevent skin from entering the cutting area and cutting into the skin of the person being treated.

However, these spacers mean that with the cutting blades known in the conventional art, i.e., the movable blades, only insufficient trimming of the treated hair area can be achieved for use for cutting close to the skin, without any risk of skin irritation or injury.

### SUMMARY

An aspect relates to a blade set for an electric hair cutting machine, and a movable blade of a blade set, which has improved cutting performance for cutting hair close to the skin, while ensuring safety that no skin injuries are caused in the process.

In order to solve the above-mentioned problem, a blade set for a hair cutting machine is provided according to embodiments of the invention, which is characterized by a special geometry of the clipper blade of the blade set.

The blade set according to embodiments of the invention for a hair cutting machine, which has a main part and the blade set connected thereto, comprises a stationary blade and a movable blade in a manner known per se. The movable blade comprises a base portion with a tooth end having a plurality of teeth formed parallel to each other, the teeth extending outwardly in the longitudinal direction of the hair cutting machine in a cutting region of the blade set with their tooth tips. The blade set according to embodiments of the invention is characterized in that the teeth of the movable blade are sized in such that their width B in the region of the respective tooth tip is substantially smaller than a distance between two adjacently arranged teeth.

The feed rate of hairs into the cutting area of the blade set is significantly influenced by the width of the tooth tips. It should be noted that the feed rate corresponds to the proportion of hairs that penetrate into the cutting area in relation to the hairs that do not penetrate due to obstacles placed in the penetration area and are therefore not cut off.

Due to the very narrow teeth of the movable blade according to embodiments of the invention, more hairs can penetrate between the shearing comb tooth gaps and advance unhindered into the cutting area, so that a significantly higher number of hairs can be cut with one cutting movement. In an embodiment of the invention, the distance A between adjacent teeth of the movable blade is about three times or more the width B of the tooth tips of the teeth of the movable blade. In embodiments of the present invention, the ratio A:B ranges from 3 to 20. Exemplarily, in the case of an A:B ratio of 20 and a tooth tip width B of 0.1 mm, the distance A between the teeth is 2 mm. Thus, the particularly narrow design of the teeth ensures that the distance between the individual teeth is effectively utilized in the cutting operation, in that a higher number of hairs can be cut with one cutting movement without significantly increasing the dimensions of the cutting area and thus of the entire hair cutting machine in the width direction.

In an embodiment, the width B of the tooth tips of the teeth of the movable blade, is substantially in the range of less than 0.24 mm and in particular in a range between 0.10 mm and 0.24 mm, and particularly, or in the range of 0.13-0.19 mm. In further particular embodiments of the present invention, the width B of the tooth tips is 0.14 and 0.18 mm.

The range of width from 0.13 to 0.19 mm of the tooth tips of the teeth of the movable blade represents an optimum, since the highest feed rate could theoretically be achieved by infinitesimally narrow tooth tips. With such narrow tooth tips, it is ensured that the mechanical strength is sufficiently guaranteed. It should be noted that the tooth tips of the teeth of the movable blade known from the conventional art have a width that is in the range of 0.28 mm. The width B of the tooth tips of the teeth of the movable blade is not necessarily measured at the edge, i.e., at the front edge, of the tooth tips. It can also be measured slightly below the front edge in the case of tooth tips that do not have a linear contour but are shaped, for example, wavy and/or curved. Although the linear front edge is considered the best performance, the other forms of the front edge also represent other embodiments of the present invention.

In an embodiment, each individual tooth extends in a pointed manner in the direction of the end of the tooth and, in particular, in the form of a regular or irregular frustum of pyramid, so that a very narrow design of the teeth can be realized without compromising the stability of the teeth during hair cutting and thus the cutting effect. The term “frustum of pyramid” refers to a geometric shape created by cutting a smaller, similar pyramid (a so-called “supplementary pyramid”) from an initial pyramid parallel to the base surfaces on the lateral surfaces. The two parallel faces of a frustum of pyramid are similar to each other. The larger of these two faces is called the base area, and the smaller is called the top area. The distance between the base and top faces is called the height of the frustum of pyramid.

The volume of a frustum of pyramid can be calculated using the following formula:

$$V = \frac{h}{3} ( {A}_{1} + \sqrt{{A}_{1} * {A}_{2}} + {A}_{2} )$$

A₁ stands for the base area, A₂ for the top area and h for the height of the frustum of pyramid. There is no simple formula for the surface area composed of trapezoids. The more oblique the pyramid or the frustum of pyramid is, the larger is the corresponding surface area. If the base surface and the top surface tend towards a circle, the geometric “extreme” is a truncated cone; if A₂ tends towards A₁, the geometric “extreme” is a prism, whose volume formula is simplified by A₁=A₂=A, and if A₂ tends towards 0, the result is a pyramid.

The shape of the frustum of pyramid is therefore in the range between the two geometric extremes of a truncated cone and a prism.

The ratio between the width B of the tooth tips of the teeth of the movable blade and the width B′ of a tooth base is in a range from 1:1.25 to 1:3 and is 1:2 in an embodiment, or 1:1.5 and 1:2.5 in still further embodiments of the invention. Even the upper value of the range, i.e., a ratio of 1:3, leads to the effect according to embodiments of the invention. Thus, a particularly stable and also effective design of the individual teeth is realized.

It is desired if the tooth tips of the teeth of the movable blade are shaped to extend substantially perpendicular to the longitudinal axis of the hair cutting machine.

In another embodiment of the invention, the tooth tips of the teeth of the movable blade are formed substantially flat, and are substantially perpendicular in the width direction to a surface serving as a cutting edge and extending downwardly in the longitudinal direction of the respective tooth, wherein an opposite end of the respective tooth tip is formed rounded.

A rounding of the edge at the top of the tooth of the movable blade in an embodiment of 90°+/−4°, ensures that there is no knife edge that can cut into the skin of the person being treated by the back and forth movement of the movable blade, or clipper knife, like a kitchen knife. In embodiments, the angle is in a range from 81° to 98°, from 83° to 96°, or for example at a value of 85° or 95°.

This tooth tip geometry with the almost right-angled design of the movable blade in the area of the tooth tips is particularly advantageous when cutting perpendicular to the skin surface in order to avoid damage to the skin of the person being treated.

The flat and wide tooth tip also offers improved cutting performance when cutting parallel to the skin surface, as the hair to be cut is gripped by the wide flank of the teeth over a longer section of hair and guided into the cutting area without being able to “slip away” from the cutting area over the front edge of the teeth, as happens disadvantageously with a pointed tooth tip. In the case of a pointed tooth tip, as known from the conventional art, the hair bends slightly over the slope of the tip and is accelerated by the reciprocating movement of the blade, resulting in a forward force which actively pushes the hair lying over the slope away from the cutting area like a downhill force.

The region following the cutting edge is designed to depart at 90°, or in a range of 81° to 98° as already explained in more detail above, i.e., this effect can even be achieved by an angle slightly smaller or slightly larger than 90°.

In an embodiment, the tooth tips have a front edge which is substantially linear in shape, with their end portions being substantially perpendicular to the front edge or being partially and/or completely rounded.

Although the linear design of the front edges is considered desired, the tooth tips can also have a rounded front edge and/or a wavy front edge, in which case the advantageous properties of the movable blade are not impaired.

The problem according to embodiments of the invention is further solved by a blade for a blade set for a hair cutting machine. The blade is a movable blade comprising a base portion and a tooth end, the blade having a plurality of teeth formed parallel to each other and extending outwardly in the longitudinal direction of the hair cutting machine in a cutting region of the blade set with their tooth tips. The blade according to embodiments of the invention is characterized in that the teeth of the movable blade are sized in such a way that their width B in the region of the respective tooth tip is substantially smaller than a distance A between two adjacently arranged teeth.

In an embodiment, the width B of the tooth tips of the teeth is substantially in the range of less than 0.24 mm, in the range of between 0.10 mm and 0.24 mm, or, in the range of about 0.13-0.19 mm. In further embodiments of the present invention, the width B of the tooth tips is 0.14 and 0.18 mm.

The width range of 0.13 to 0.19 mm of the tooth tips of the teeth of the movable blade represents an optimum, as already explained above, since the highest feed rate could theoretically be achieved by infinitesimally narrow tooth tips.

In an embodiment, the tooth tips of the teeth of the blade according to the invention are formed substantially flat and extend in the width direction substantially perpendicular to a surface serving as a cutting edge and extending downwardly in the longitudinal direction of the respective tooth, wherein an opposite end of the respective tooth tip is formed rounded.

In an embodiment, the tooth tips of the blade according to the invention have an edge which is substantially linear, with their end portions being substantially perpendicular to the edge or being partially and/or completely rounded, and with a region adjacent to the cutting edge corresponding to a stationary blade, departing at an angle in a range of 81 to 98°, or 90°, as has already been explained in more detail above, to which explicit reference is also made here. However, the blade according to embodiments of the invention can also be designed in such a way that the tooth tips have a rounded edge and/or a wavy edge.

According to embodiments of the invention, there is also provided a hair cutting machine having a housing body and a blade set connected thereto.

### BRIEF DESCRIPTION

Some of the embodiments will be described in detail, with references to the following Figures, wherein like designations denote like members, wherein:

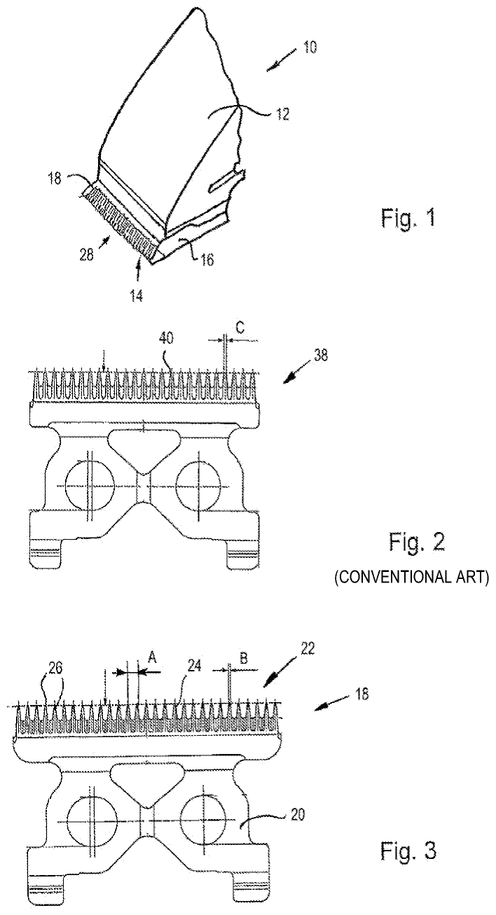

FIG. 1 shows a partial perspective view of a hair cutting machine according to the invention with the blade set according to one embodiment of the present invention;

FIG. 2 shows a top view of a conventional art movable blade;

FIG. 3 shows a top view of a movable blade according to one embodiment of the present invention;

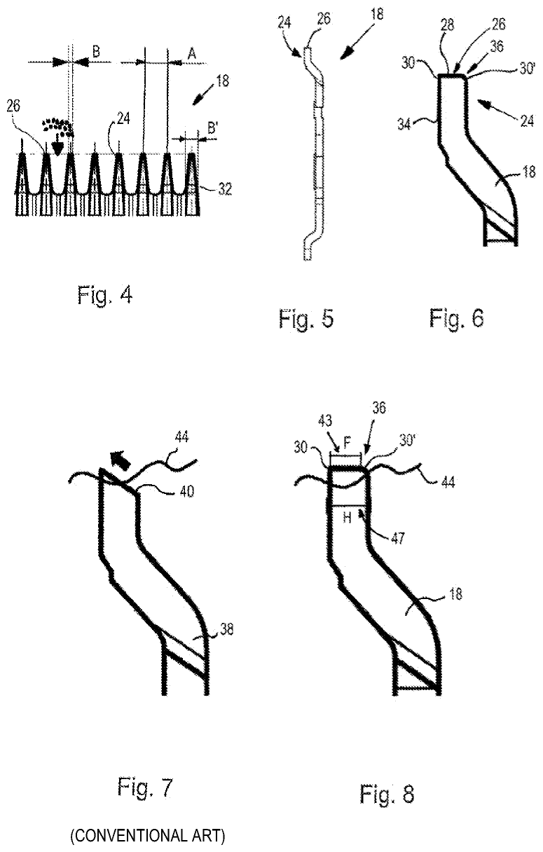

FIG. 4 shows an enlarged partial view of a movable blade in the area of the teeth according to FIG. 3;

FIG. 5 shows a side view of a movable blade according to FIG. 3;

FIG. 6 shows an enlarged partial side view in the area of a tooth of the movable blade according to FIG. 5;

FIG. 7 shows an enlarged partial side view in the region of a tooth of the conventional art movable blade;

FIG. 8 shows an enlarged partial side view in the region of a tooth of the movable blade, as shown in FIG. 6.

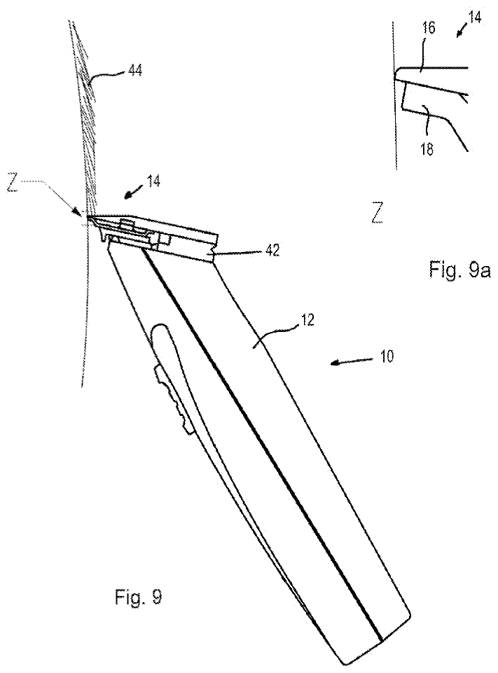

FIG. 9 shows a schematic side view of a hair cutting machine according to embodiments of the invention with the installed blade set; and

FIG. 9a shows a magnified view of the blade set according to FIG. 9 in the area of the tooth tips.

### DETAILED DESCRIPTION

FIG. 1 shows a partial perspective view of a hair cutting machine 10 according to embodiments of the invention with the blade set 14 according to one embodiment of the present invention. The hair cutting machine 10 comprises a main part 12 to which the blade set 14 is connected.

The blade set 14 has a stationary blade 16 and a movable blade 18 in connection with each other, wherein, as can be seen from FIG. 1, the movable blade 18 is disposed on the stationary blade 16 below. The stationary blade 16 is thereby in contact with the skin of the person or user to be treated and is also referred to as a so-called shearing comb or just “comb”.

Both the stationary blade 16 and the movable blade 18 have a toothed edge and are arranged one above the other such that the respective toothed edges overlap. The two blades 16 and 18 move back and forth relative to each other during operation to enable a cutting operation.

Both the stationary blade 16 and the movable blade 18 of the blade set 14 shown in FIG. 1 comprise a base section, not shown here, via which the two blades are connected to each other and also to the main part of the hair cutting machine.

In FIG. 3, the movable blade 18 is shown in a plan view. Here, the blade 18 comprises a base portion 20 which includes a tooth end 22 with a plurality of teeth 24 formed parallel to each other, the teeth 24 extending outward in the longitudinal direction of the hair cutting machine in a cutting region of the blade set with their tooth tips 26.

As shown in FIG. 3, the teeth 24 of the movable blade 18 are sized in such a way that their width B in the region of the respective tooth tip 26 is substantially smaller than a distance A between each two adjacently arranged teeth 24. In this case, the width B is in the range of less than 0.24 mm. The width may well lie in a range between 0.10 mm to 0.24 mm. A width of 0.18 mm or even of 0.16 mm is considered to be an embodiment of the invention.

FIG. 4 shows an enlarged partial view of the movable blade 18 in the region of the teeth 24 as shown in FIG. 3. From this enlarged view, it is apparent that the width B is substantially smaller than a distance A between each two adjacent teeth 24. With the arrow pointing downward, it is shown that the hairs to be cut enter the intermediate zone between two adjacent teeth 24.

Due to the considerably larger distance A compared to the width B of the tooth tip 26, it is possible to increase the feed rate, i.e., the proportion of hairs which advance into the cutting area. The advanced hairs are shown schematically as dots above the arrow in FIG. 4.

As can be seen from FIG. 4, the ratio between the width B of the tooth tips 26 of the teeth 24 of the movable blade 18 and the width B′ of a tooth base 32 is about 1:2. However, this ratio may well be 1:3. In this case, the tooth may extend in a wedge shape in the direction of the tooth tip 26.

FIG. 2 shows a conventional art movable blade 38, or shear blade, from which it is apparent that the width C in the region of a tooth tip 40 is substantially greater than the width B in the region of the tooth tip of the teeth of the movable blade shown in FIG. 3. The width C, as shown in FIG. 2, is generally about 0.28 mm according to the conventional art.

FIG. 5 shows a side view of a movable blade 18 as shown in FIG. 3. In this figure, the geometry of the movable blade 18 can be clearly seen, and in the area of the teeth 24, it can be clearly seen that the tip of the teeth 26 is flattened.

From FIG. 6, which shows an enlarged partial side view in the region of a tooth 24 of the movable blade 18 shown in FIG. 5, it is apparent that the tooth tip 26 has a flat edge 28. The tooth 24 has a cutting edge 34 that corresponds with the underlying stationary blade set, which is not shown here, and serves as a running surface that slides against the underlying tooth. The edge 28 on the tooth tip 26 provides a surface that can come into contact with the skin of the person being treated. In this regard, the tooth tip has a rounded end 36.

In this embodiment shown in FIG. 6, the edge 28 extends perpendicular to the cutting edge 34, with the two edges meeting at a first end portion 30, and with a second end portion 30′ formed rounded at an opposite end of the edge 28.

This embodiment according to FIG. 6 is shown enlarged in FIG. 8 for better illustration. The end section 30 has a straight part 43, designated F, which extends to the beginning of the rounding of the rounded end section 30′. The height 47 of the cutting tooth is designated H. In the context of embodiments of the present invention, the ratio of F to H is in the range of 0.6 to 0.95, 0.65 to 0.8, and or values are 0.7, 0.75 and 0.8.

The 90° plus the radius (or “round edge”) design on the top of the movable blade 18 ensures that there is no knife edge to cut into the skin due to the reciprocating motion of the movable blade 18.

This tooth tip geometry is particularly advantageous when cutting perpendicular to the skin surface to avoid damage to the skin of the person being treated, as shown in FIGS. 9 and 9a. In FIG. 9a, which shows an enlarged view of the blade set 14 according to embodiments of the invention with the stationary blade 16 and the movable blade 18, from which cutting perpendicular to the skin surface and the orientation of the blade set 14 can be seen. In the embodiment example of the hair cutting machine 10 according to embodiments of the invention shown in FIG. 9, the blade set 14 is attached to a cutting set carrier 42 and is insertable and fixable in a receptacle provided therefor in the main part 12 of the hair cutting machine 10. However, it is also possible for the blade set 14 to be detachably connected to the main part 12 of the hair cutting machine 10 by means of fastening means, such as screws.

Not only when cutting perpendicular to the skin surface, but also parallel to the skin surface, the flat and wide tooth tip offers improved cutting performance, since the hair to be cut is gripped by the wide flank of the teeth over a longer section of hair and guided into the cutting area without being able to “slip away” from the cutting area over the front edge of the teeth, as happens with a pointed tooth tip 40 as known from the conventional art and shown in FIG. 7. In such a pointed tooth tip, as shown in FIG. 7, the hair to be cut bends over the slope of the tip and is accelerated by the reciprocating movement of the blade, resulting in a forwardly directed force which actively pushes the hair 44 lying over the slope away from the cutting area like a slope drive force. The hair 44 is shown with the wavy line in FIGS. 7 and 8.

The area adjacent to the cutting edge can be designed with an angle of 90° or also in an angle range of 81° to 98°—as explained in more detail above—i.e., this effect can even be achieved by an angle slightly smaller or slightly larger than 90°.

Although the invention has been illustrated and described in greater detail with reference to the exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCE SIGNS

10 hair cutting machines
12 main part
14 blade set
16 fixed blade
18 movable blade
20 base portion
22 tooth end
24 tooth
26 tooth tip
28 flat edge
30 first end section of edge 28
30′ second end section of edge 28
32 tooth base
34 cutting edge
36 rounded end of the tooth tip
38 movable blade (according to the state of the art)
40 tooth tip (according to the state of the art)
42 cutting set support
44 hair
47 height of the cutting tooth

1. A blade set for a hair cutting machine comprising a main part and a blade set fixed thereto, wherein the blade set has a stationary blade and a movable blade, wherein the movable blade comprises a base portion having a tooth end with a plurality of teeth formed parallel to each other, wherein the tooth tips of the teeth extend toward the outside in the longitudinal direction of the hair cutting machine in a cutting region of the blade set,
wherein the teeth of the movable blade are sized in such that the width thereof is substantially smaller in the region of the particular tooth tip than a distance between two respective adjacently arranged teeth.

2. The blade set according to claim 1, wherein the distance between the adjacent teeth is about three times the width of the tooth tips of the teeth of the movable blade.

3. The blade set according to claim 1, wherein the width of the tooth tips of the teeth of the movable blade, is substantially in a range of less than 0.24 mm, in a range between 0.10 mm and 0.24 mm or in the range of 0.18 mm.

4. The blade set according to claim 1, wherein each individual tooth extends in a pointed manner towards the tooth end and in particular in the form of a truncated frustum of pyramid.

5. The blade set according to claim 1, wherein the tooth tips extend substantially perpendicular to the longitudinal axis of the hair cutting machine.

6. The blade set according to claim 1, wherein the tooth tips of the teeth of the movable blade are formed substantially flat and extend in the width direction substantially perpendicular to a surface serving as a cutting edge and extending downwardly in the longitudinal direction of the respective tooth and corresponding to the stationary blade, wherein an opposite end of the respective tooth tip is formed rounded.

7. The blade set according to claim 1, wherein the tooth tips comprise an edge which is substantially linear, wherein their end portions being substantially perpendicular to the edge or being partially and/or completely rounded, and an area adjacent to a cutting edge corresponding to the stationary blade is configured to extend at 90°.

8. The blade set according to claim 1, wherein the tooth tips comprise a rounded edge and/or wavy formed edge.

9. The blade set according to claim 1, wherein the end portion of the tooth tip comprises a straight part F extending to the beginning of the rounding of the rounded end portion 30′ and wherein the ratio of the lengths of the straight part F to the height H of the cutting tooth is in a range of 0.6 to 0.95 or 0.65 to 0.8.

10. The blade set according to claim 1, wherein the ratio between the width of the tooth tips of the teeth of the movable blade and the width of a tooth base is about 1:2.

11. The blade for a blade set for a hair cutting machine, wherein the blade comprises a movable blade and a base portion and a tooth end, wherein the blade comprises a plurality of teeth formed parallel to each other and extending outwardly in the longitudinal direction of the hair cutting machine in a cutting area of the blade set with their tooth tips,
wherein the teeth of the movable blade are sized in such that the width thereof is substantially smaller in the region of the particular tooth tip than a distance between two respective adjacently arranged teeth.

12. The blade according to claim 11, wherein the width of the tooth tips of the teeth is substantially in the range of less than 0.24 mm, or in a range between 0.10 mm and 0.24 mm.

13. The blade according to claim 1, wherein the end portion of the tooth tip comprises a straight part F extending to the beginning of the rounding of the rounded end portion 30′ and wherein the ratio of the lengths of the straight part F to the height H of the cutting tooth is in a range of 0.6 to 0.95 or 0.65 to 0.8.

14. The blade according to claim 11, wherein the tooth tips of the teeth are formed substantially flat, and extend in the width direction substantially perpendicular to a surface serving as a cutting edge and extending downward in the longitudinal direction of the respective tooth, wherein an opposite end of the respective tooth tip is formed rounded.

15. The blade according to claim 11, wherein the tooth tips comprise an edge which is substantially formed linear, wherein their end portions extend substantially perpendicular to the edge or being partially and/or completely rounded, and wherein a region adjacent to the cutting edge corresponding to a fixedly connected blade is feasible to extend at about 90°.

16. The blade according to claim 11, wherein the tooth tips have a rounded edge and/or wavy edge.

17. A hair cutting machine comprising a housing body and a blade set connected thereto according to claim 1.
